(19) United States
(12) Patent Application Publication
(10) Pub. No.: US 2011/0242112 A1
(43) Pub. Date: Oct. 6, 2011

(54) Display device and driving circuit thereof

(75) Inventors: Yukari KATAYAMA, Chigasaki (JP); Akihito Akai, Kawasaki (JP); Yoshiki Kurokawa, Tokyo (JP); Takashi Shoji, Yokohama (JP)

(73) Assignee: RENESAS TECHNOLOGY CORP.

(21) Appl. No.: 12/750,794

(22) Filed: Mar. 31, 2010

(51) Int. Cl. G06T 1/00; G06T 9/00

(52) U.S. Cl. 345/501; 345/555

(57) ABSTRACT

The display driver includes: a display data compression circuit; a recording circuit; a display data decompression circuit; and an output circuit. Further, the display driver is provided with a compressibility setting circuit. The display data compression circuit has the function of compressing the display data according to a compressibility set by the compressibility setting circuit. With the display driver arranged like this, the power consumption can be reduced by increasing the compressibility for a displayed image such that the image quality is not noticeably deteriorated even with the compressibility increased. Further, for the displayed image such that the image quality is noticeably deteriorated with the compressibility increased, a sufficient image quality after data decompression can be secured by lowering the compressibility.

### FIELD OF THE INVENTION

The present invention relates to a technique for compression of display data, and particularly to a technique useful in application to a display driver and a display unit.

### BACKGROUND OF THE INVENTION

In recent years, with regard to mobile devices including mobile phones, the enhancement in the definition of display panels has been proceeding, and consequently VGA resolution and display with HD image quality have been becoming a mainstream with display panels. The enhancement in the definition of display panels leads to the increase in power consumed by transfer of display data. Hence, a measure which includes incorporating a frame memory in a driver, and transferring display data only at the time of change of a video image is taken to cut the power consumption. However, the enlargement of a frame memory owing to the enhancement of the definition of display panels, and the increase of power consumed by readout from the frame memory become problems.

As a means for coping with the problem of the enlargement of a frame memory, a technique for making smaller the frame memory, which follows the step of compressing display data thereby to decrease the amount of data in a driver for display, has been proposed. Such technique is described in e.g. Japanese Unexamined Patent Publications JP-A-2007-108439 and JP-A-2006-338028. The power consumed by the readout from a frame memory can be kept small by decreasing the amount of data in the frame memory.

### SUMMARY OF THE INVENTION

After consideration about the conventional technique as described above, the inventor found that they have various problems including five problems:

(1) Display data is compressed to the size of a frame memory prepared in a driver, and stored therein, and at the time of display, the data is decompressed and then displayed on a display unit. In general, the image quality of a displayed image after data decompression is deteriorated under the condition that the compressibility is large, or the after-compression frame memory size is decreased as described in the patent documents concerned with the related art and cited above. The relation between the compressibility, and the after-decompression image quality of a displayed image varies depending on the displayed image. In general, with regard to e.g. a solid image or a natural image varying gently, the deterioration of image quality is small even when the compressibility is made larger. The deterioration of image quality on e.g. a user interface image involving many fine edges is larger than that caused on a solid image or the like even with the same compressibility. Therefore, as to user interface images having many fine edges, the deterioration of image quality becomes larger if compressing all images with the same compressibility. In addition, the cutting ratio of power consumption cannot be increased even in the case of displaying a solid image, a natural image which varies gently, or the like.

(2) A display screen of e.g. a mobile phone is divided into smaller areas, and display is performed on such smaller areas. The areas include areas where icons for showing the condition of electric waves, the time, etc. are displayed at all times, and an area where e.g. a natural picture or a moving picture is displayed. As described above, a user interface image and a natural image are different from each other in characteristics. Therefore, under the condition that display data are compressed with the same compressibility, the image quality of a user interface image is deteriorated, and the power consumption cannot be decreased greatly with a natural picture.

(3) The power consumed by transfer of display data between CPU and a display driver is increased with the enhancement of definition, which becomes a problem. Further, in recent years, requirements of data transfer of touch information from a display screen to CPU increase because of e.g. the advent of high-performance touch panels, and the amount of data transferred through a bus between CPU and a display driver increases.

(4) A user interface image displayed on a mobile phone or the like differs from a natural image in characteristics. Therefore, when using a common compression algorithm to compress display data of these images, a user interface image is deteriorated in image quality, rather than a natural image.

(5) CPUs of mobile phones are required to handle an enormous amounts of processing. Therefore, it is difficult to make a judgment concerning a compressibility and make the setting thereof for each displayed image.

Hence, it is an object of the invention to provide a technique having the following advantages. The first is that the power consumption can be cut by increasing the compressibility on a displayed image such that the image quality is not noticeably deteriorated even with the compressibility increased. The second is that a sufficient image quality after data decompression can be secured by lowering the compressibility on a displayed image such that a large deterioration of image quality is caused by increasing the compressibility.

It is another object of the invention to provide a display data compression/decompression technique in connection with a display unit and a display driver, which are arranged to display a different kind of image in each area, and the technique has the following advantages. The first is that the power consumption can be cut by increasing the compressibility on a display area of a displayed image where the image quality is not noticeably deteriorated even with the compressibility increased. The second is that a sufficient image quality after data decompression can be secured by lowering the compressibility on a display area of a displayed image where a large deterioration of image quality is caused by increasing the compressibility.

It is another object of the invention to provide a technique having the following advantages. The first is that the power consumed by a bus between CPU and a display driver is cut. The second is that the percentage of the bus used for transfer of display data is reduced. The third is that the power consumption can be cut by increasing the compressibility on a displayed image such that the image quality is not noticeably deteriorated even with the compressibility increased. The fourth is that a sufficient image quality after data decompression can be secured by lowering the compressibility on a displayed image such that a large deterioration of image quality is caused by increasing the compressibility.

It is another object of the invention to provide a display data compression/decompression technique for compressing display data while using a different algorithm for each area in connection with a display unit and a display driver, which are arranged to display a different kind of image in each area, whereby a sufficient image quality can be secured even after data decompression.

It is another object of the invention to provide a technique having the following advantages in connection with a display unit and a display driver. The first is that a displayed image such that the image quality is not noticeably deteriorated even with the compressibility increased, and a displayed image such that the image quality is noticeably deteriorated with the compressibility increased can be automatically discriminated from each other. The second is that the compressibility can be changed for each displayed image.

The above and other objects of the invention and a novel feature thereof will becomes clear from the description hereof and the accompanying drawing.

Now, a display driver according to a representative embodiment of the invention herein disclosed will be outlined below.

To achieve the above-described object, the display driver is arranged to have a compressibility setting circuit, which enables the setting of the compressibility of display data. The display driver includes a display data compression circuit, which is provided with the function of compressing display data with a compressibility set by the compressibility setting circuit.

Further, to achieve the above-described object, the display driver is arranged to have: a display region divided into more than one display area; a display area setting circuit for setting the position of each display area so that a compressibility can be set for each display area; and a compressibility setting circuit for setting a compressibility for each display area.

To achieve the above-described object, the display driver has a compression-mode setting circuit which can set a compression mode fitting each display area, in which the compression mode is switched according to a setting value of the compression-mode setting circuit, and a display position of display data, and then the display data is compressed.

To achieve the above-described object, in regard to the display driver, the compression of display data of an image includes at least the step of performing quantization using a quantization parameter, and the display driver has a circuit operable to update a value set by the compressibility setting circuit, provided that the update is conducted depending on a value taken by the quantization parameter.

To achieve the above-described object, a compressibility setting circuit operable to set the compressibility of the display data is provided in CPU, and the display data compression circuit has the function of compressing display data according to a compressibility set by the compressibility setting circuit. Further, the display driver is arranged so that display data compressed by the display data compression circuit is transferred to the display data decompression circuit through a recording circuit.

Now, the effects achieved by the display driver according to the embodiment will be briefly described below.

It is possible to provide a technique having the following advantages. The first is that the power consumption can be cut by increasing the compressibility, concerning a display image such that the image quality is not noticeably deteriorated even with the compressibility increased. The second is that with a display image such that a large deterioration of image quality is caused by increasing the compressibility, a sufficient image quality after data decompression can be secured by lowering the compressibility.

It is possible to provide a display data compression/decompression technique having the following advantages. The first is that on condition that a different kind of image is displayed in each area, the power consumption can be reduced by increasing the compressibility in regard to a display area of a displayed image such that the image quality is not noticeably deteriorated even with the compressibility increased, and a sufficient image quality after data decompression can be secured by lowering the compressibility on a display area of a displayed image such that the image quality is noticeably deteriorated with the compressibility increased.

It is possible to provide a technique having the following advantages. The first is that the power consumed by a bus is cut. The second is that the percentage of the bus used for transfer of display data is reduced. The third is that the power consumption can be cut by increasing the compressibility on a displayed image such that the image quality is not noticeably deteriorated even with the compressibility increased. The fourth is that a sufficient image quality after data decompression can be secured by lowering the compressibility on a displayed image such that the image quality is noticeably deteriorated with the compressibility increased.

It is possible to provide a display data compression/decompression technique for a display unit and a display driver, which are arranged to display a different kind of image in each area; the technique has the following advantage. That is, display data are compressed using a different algorithm for each area and as such, a sufficient image quality after data decompression can be secured.

It is possible to provide a technique for a display unit and a display driver, which are arranged to automatically discriminate between a displayed image such that the image quality is not noticeably deteriorated even with the compressibility increased, and a displayed image such that the image quality is noticeably deteriorated with the compressibility increased, whereby the compressibility can be changed for each displayed image.

### BRIEF DESCRIPTION OF THE DRAWINGS

FIG. 1 is a block diagram showing a display unit according to the first embodiment of the invention;

FIG. 2 is a block diagram showing a typical display data compression circuit;

FIG. 3 is a block diagram showing a display data compression circuit according to the first embodiment of the invention;

FIG. 4 is a block diagram showing a display data decompression circuit according to the first embodiment;

FIG. 5 is a diagram showing an image of division of a display region in a display unit according to the second embodiment of the invention;

FIG. 6 is a block diagram showing the display unit according to the second embodiment of the invention;

FIG. 7 is a block diagram showing a display data compression circuit according to the second embodiment of the invention;

FIG. 8 is a block diagram showing a display data decompression circuit according to the second embodiment of the invention;

FIG. 9 is a block diagram showing a display unit according to the third embodiment of the invention;

FIG. 10 is a block diagram showing a display unit according to the fourth embodiment of the invention;

FIG. 11 is a detailed block diagram showing a BTC compression circuit according to the fourth embodiment of the invention;

FIG. 12 is a diagram for explaining the concept of a BTC compression algorithm of the BTC compression circuit according to the fourth embodiment of the invention;

FIG. 13 is a block diagram showing a display data compression circuit according to the fourth embodiment of the invention; and

FIG. 14 is a block diagram showing a display data decompression circuit according to the fourth embodiment of the invention.

### DETAILED DESCRIPTION OF THE PREFERRED EMBODIMENTS

### 1. Brief Description of the Preferred Embodiments

A representative embodiment of the invention herein disclosed will be outlined first. Here, the reference numerals to refer to the drawings, which are accompanied with paired round brackets, only exemplify what the concepts of parts or components referred to by the numerals contain.

[1] A display driver (101) according to a preferred embodiment of the invention includes: a display data compression circuit (109) operable to compress display data of an image thereby to reduce a data amount of the display data; a recording circuit (110) operable to store the display data compressed by the display data compression circuit; a display data decompression circuit (111) operable to decompress display data read from the recording circuit; and an output circuit (112, 113) operable to output display data decompressed by the display data decompression circuit to a display section. The display driver further includes a compressibility setting circuit (107) operable to set a compressibility of the display data. The display data compression circuit includes a function for compressing the display data with the compressibility set by the compressibility setting circuit.

According to the above arrangement, with a displayed image such that the image quality is not noticeably deteriorated even with the compressibility increased, the power consumption can be cut by increasing the compressibility, whereas in regard to a displayed image such that the image quality is noticeably deteriorated with the compressibility increased, a sufficient image quality after data decompression can be secured by lowering the compressibility.

[2] The display driver as described in [1] further includes a display area setting circuit (107) operable to set a plurality of display areas. The compressibility setting circuit includes a function for setting a compressibility corresponding to each display area. The display data compression circuit includes a function for switching the compressibility and compressing display data according to a value set by the display area setting circuit, and a display position of the display data. According to this arrangement, the following effect is achieved in regard to a display unit and a display driver, which are arranged to display a different kind of image in each area. As for a display area of a displayed image such that the image quality is not noticeably deteriorated even with the compressibility increased, the power consumption can be cut by increasing the compressibility, whereas on a display area of a displayed image where a large deterioration of image quantity is caused by increasing the compressibility, a sufficient image quality after data decompression can be secured by lowering the compressibility.

[3] The display driver as described in [2] further includes a compression-mode setting circuit (1001) operable to set a compression mode corresponding to each display area. In addition, the display data compression circuit switches the compression mode and compresses display data according to a value set by the compression-mode setting circuit and a display position of the display data. According to this arrangement, the following effects are achieved. The first is that the power consumed by a bus is cut. The second is that the percentage of the bus used for transfer of display data is reduced. The third is that the power consumption can be cut by increasing the compressibility on a displayed image such that the image quality is not noticeably deteriorated even with the compressibility increased. The fourth is that a sufficient image quality after data decompression can be secured by lowering the compressibility on a displayed image such that the image quality is noticeably deteriorated with the compressibility increased.

[4] In regard to the display driver as described in [1], the compression of display data of an image includes at least the step of performing quantization using a quantization parameter. In addition, the display driver further includes a circuit (1305) operable to update a value set by the compressibility setting circuit, wherein the update is conducted depending on a value taken by the quantization parameter. According to this arrangement, the following effect is achieved in regard to a display unit and a display driver, which are arranged to display a different kind of image in each area. That is, a sufficient image quality after data decompression can be secured by using a different algorithm for each area to compress display data.

[5] The display unit (100) includes a display driver (101), and a display section (105). The display driver (101) includes: a CPU (102) having a display data compression circuit (901) operable to compress display data of an image thereby to reduce a data amount of the display data; a recording circuit (110) operable to store compressed display data; a display data decompression circuit (111) operable to decompress display data read from the recording circuit; and an output circuit (112, 113) operable to output display data decompressed by the display data decompression circuit. The CPU (102) includes a compressibility setting circuit (902) operable to set a compressibility of the display data. The display data compression circuit includes a function for compressing the display data with the compressibility set by the compressibility setting circuit. Display data compressed by the display data compression circuit is transmitted to the display data decompression circuit through the recording circuit.

According to the above arrangement, the following effect is achieved with regard to a display unit and a display driver. That is, it is possible to automatically discriminate between a displayed image such that the image quality is not noticeably deteriorated even with the compressibility increased, and a displayed image such that the image quality is noticeably deteriorated with the compressibility increased, whereby the compressibility can be changed for each displayed image.

### 2. Further Detailed Description of the Preferred Embodiments

Next, the preferred embodiments will be described further in detail.

Now, it is noted that as to all the drawings to which reference is made in describing the embodiments, like parts or members are identified by the same reference numerals to avoid the repetition of their descriptions.

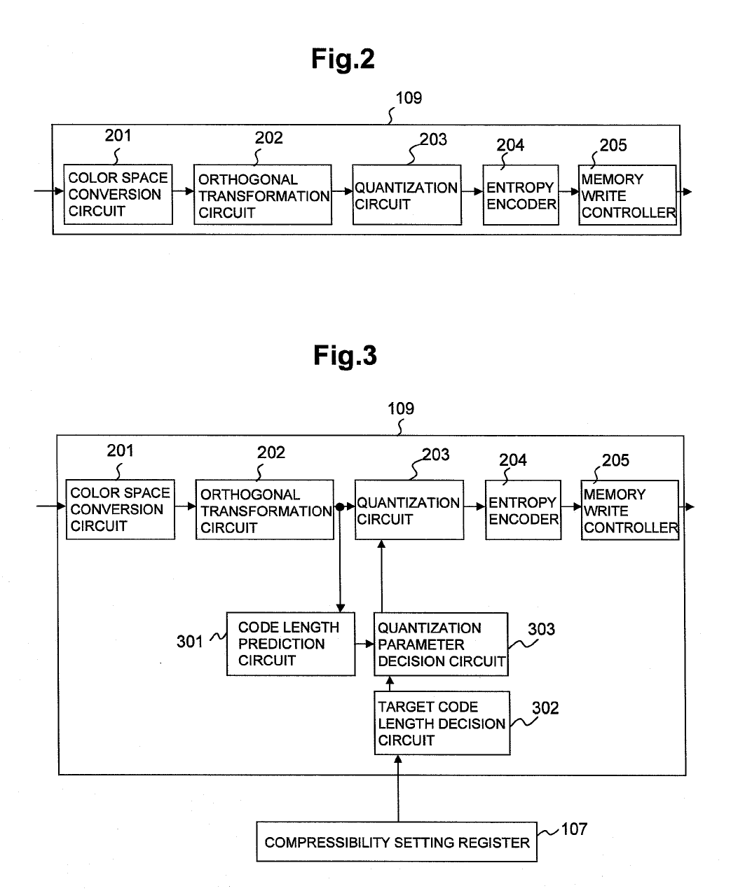

In general, there are two typical compression methods for compressing image data of a still image. The first is that a method which includes the orthogonal transformation and entropy encoder, by which compression is performed following the blocks as shown in FIG. 2. The second is that a method referred to as BTC (Block Truncation Coding). Next, the two methods will be briefly outlined below.

First, with reference to FIG. 2, the description is presented on the method which includes the orthogonal transformation and entropy encoder. In FIG. 2, the reference numeral 201 denotes a block which performs a color space conversion. In general, a display driver, such as LC driver, receives a displayed image in RGB format from CPU. Now, it is noted that LC is an abbreviation for “Liquid Crystal”. RGB hue format is the one which involves many overlaps of colors. Therefore, the format using color spaces, which is smaller in the number of overlaps between parameters, is used in the process of compression in general. Various kinds of color spaces for compression, e.g. YUV, YCbCr and YCoCg are proposed. The kinds of color spaces to be compressed have no influence on the invention, and any kind of color space may be used. The color-space-conversion circuit 201 converts RGB data into color space data for compression.

The reference numeral 202 denotes an orthogonal-transformation circuit. The orthogonal-transformation circuit divides a displayed image into blocks of e.g. 4×4 pixels, 8×8 pixels or 16×16 pixels, and conducts an arithmetic operation with an orthogonal transformation matrix, thereby to divide color data located in a space into low-frequency and high-frequency components. Data compression is performed taking the advantage of the fact that in general, a high-frequency component takes a small value. Examples of the orthogonal transformation include Hadamard transformation, DCT used for e.g. MPEG and JPEG, and Wavelet used for e.g. JPEG2000. Also, the orthogonal matrix of orthogonal transformation can take various structures, such as 4×4, 8×8 and 16×16. These kinds of orthogonal transformation have no influence on the invention, and therefore any kind of orthogonal transformation may be adopted.

The reference numeral 203 denotes a quantization circuit, which divides a value resulting from the orthogonal transformation by a constant, thereby making smaller the value. The constant is referred to as “a quantization parameter”.

The reference numeral 204 denotes an entropy encoder. The entropy encoder is a coding method such that a code with a different length is assigned according to the emergence probability of a numerical value. In general, a high-frequency component almost certainly has a small value such as 0 or 1. Therefore, in the step of compression, the entropy encoder is performed to assign a one-bit code zero (0) having the highest emergence probability, whereby the amount of data is decreased. Example of the entropy code include Huffman code and Exp-Golomb code. Also, these kinds of entropy codes have no influence on the invention, and therefore any kind of entropy code may be used.

The reference numeral 205 denotes a memory-write control block. The block records variable-length codes by packing the codes in a memory, and thus data are compressed.

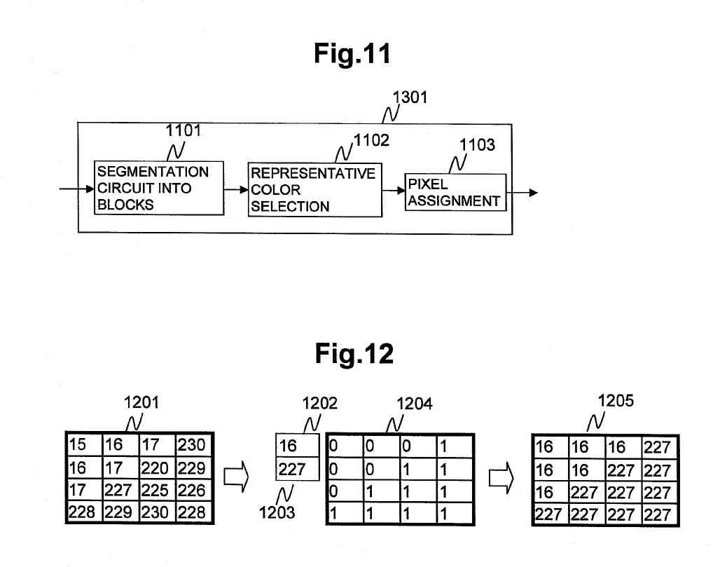

Next, BTC will be described with reference to FIGS. 11 and 12. Also, in BTC, a displayed image is divided into blocks with a size of e.g. 4×4 or 8×8, and is subjected to compression. First, a segmentation circuit into blocks 1101 divides a displayed image into blocks as shown in FIG. 11. For example, it is assumed that a displayed image is divided into blocks of 4×4 pixels. Here, it is supposed, for example, that with a certain block, R signal of R, G and B signals takes a value denoted by the numeral 1201. A representative color selection 1102 extracts a typical value. Various extraction methods have been proposed as the means for extracting a typical value. An example of such means is a method, which includes extracting, as typical values, the mean of values above a threshold and the mean of values below the threshold provided that the mean of all of the blocks is set as the threshold. In this way, the typical values 1202 and 1203 are extracted. In this case, the typical values are e.g. 16 and 227. The pixel assignment 1103 uses the mean of all the blocks as a threshold, and assigns R values of the pixels to zero (0) or one (1) as shown by the numeral 1204. G and B data are transformed likewise. For example, on condition that each pixel value of R is expressed with 8 bits, as a result of the transformation, each block can be expressed by 32 bits after compression; 32 bits consists of 16 bits for two typical values, which is derived from the calculation “8 bits multiplied by 2 equals sixteen bits”, and 16 bits assigned to individual pixels. Before compression, 128 bits—derived from the calculation “eight bits multiplied by sixteen equals 128 bits”—are assigned for each block. Therefore, a displayed image will be compressed to a quarter of it in size. At the step of decompression, each pixel value, i.e. zero (0) or one (1), is replaced with a typical value as shown by the numeral 1205. In BTC, compression is performed in this way. The increase in the number of typical values enhances the image quality after decompression, however lowers the compressibility.

There are still image compression algorithms intended for the two methods. In general, a compression method arranged based on a combination of the orthogonal transformation and entropy code is suitable for a displayed image which involves fewer edges and varies gently, whereas BTC is suitable for a displayed image with a small number of colors.

### First Embodiment

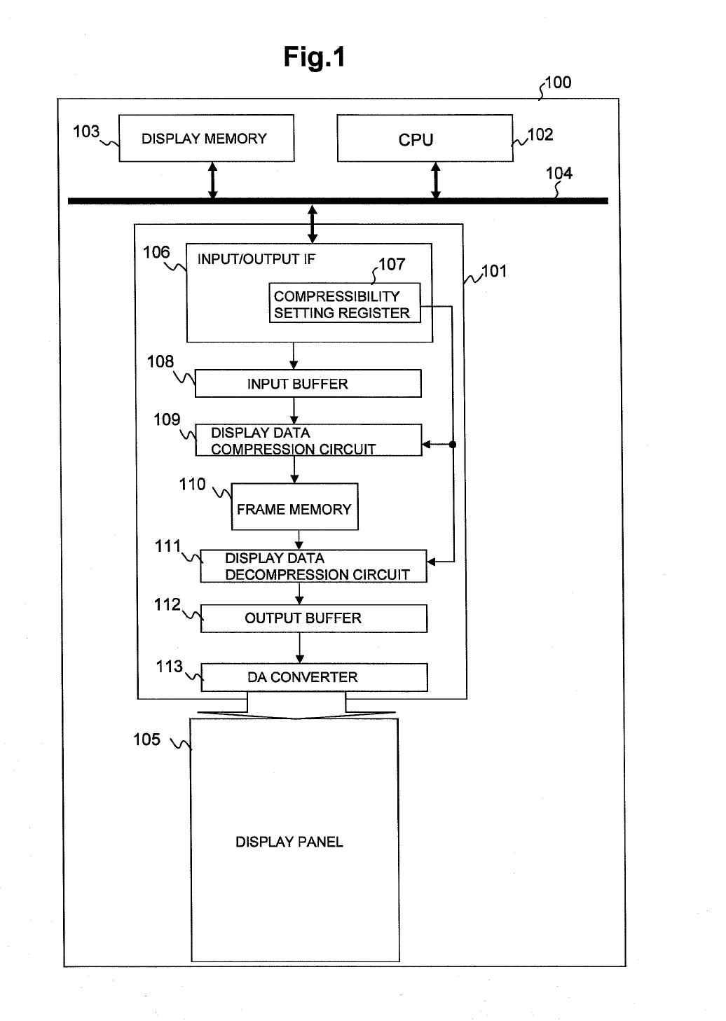

Next, the first embodiment will be described in detail. FIG. 1 is a block diagram showing a display unit according to the first embodiment of the invention. The reference numeral 100 denotes a display unit of a mobile phone or the like. The numeral 101 denotes a display driver, such as an LC driver. The numeral 102 denotes CPU (Central Processing Unit) which controls, in whole, a display unit such as a mobile phone. The numeral 103 denotes a display memory to store display data, etc. The numeral 104 denotes an internal bus. The numeral 105 denotes a display panel which is driven by the display driver 101 and produces a display. The display panel may be any of an LC panel, an organic EL (Electro-Luminescence) panel, PDP (Plasma Display Panel), FED (Field Emission Display), and an electronic paper, for example.

The numeral 106 denotes an I/O interface circuit which has a group of registers (not shown) for making settings of various modes, and which receives display data from the CPU 102 and display memory 103. The numeral 107 denotes a compressibility setting register for setting the compressibility of display data used in a display data compression circuit to be described later, which is one of the group of registers included in the I/O interface circuit. The numeral 108 denotes an input buffer. In general, the transfer of display data from CPU is performed by sending the data in units of line in a horizontal direction. However, the orthogonal transformation is conducted in blocks of e.g. 4×4, 8×8, or 16×16 pixels, and therefore it needs an input buffer for buffering 4 pixels×2 rows, 8 pixels×2 rows or 16 pixels×2 rows. The numeral 109 denotes a display data compression circuit. The block compresses display data, and writes the data thus compressed into the frame memory 110.

The numeral 111 denotes a display data decompression circuit, which decompresses the compressed display data read out from the frame memory, and transfer the resulting data to the output buffer 112. Usually, decompression of data is performed in blocks of e.g. 4×4, 8×8 or 16×16 pixels, which is a unit of the orthogonal transformation. A unit of transfer to DA (Digital-to-Analog) Converter 113 is one line. Therefore, the output buffer waits for data of a volume containing the capacity of one line. After the waiting time, the data are output to DA (Digital-to-Analog) converter 113, and then output onto the display panel 105. Incidentally, on condition that the display driver is a controller-driver for a panel such as an LC panel controlled with an analog voltage, DA converter 113 is used here. However, it is also possible to use a current-driven or pulse-driven display panel, instead. The DA converter 113 can be replaced with other module or member depending on the means for driving the display panel 105. Therefore, the alternative to the DA converter 113 may be any functional block as long as it serves as a circuit operable to convert the digital value of each display pixel to a format of signal, by which the display panel can be driven. Even if a circuit block of the DA converter 113 is replaced with another one having another function, it has no influence on the invention.

Now, with reference to FIG. 3, the circuit arrangement inside the display data compression circuit 109 will be described in detail. The display data compression circuit 109 of FIG. 3 adopts a compression method using a combination of the orthogonal transformation and entropy encoder. The color-space-conversion circuit 201, orthogonal-transformation circuit 202, quantization circuit 203, entropy encoder 204 and memory-write controller 205 are the same as those shown in FIG. 2. Unlike the compression circuit shown in FIG. 2, the display data compression circuit 109 has a code-length-prediction circuit 301; a target-code-length decision circuit 302, and a quantization parameter decision circuit 303. The target-code-length decision circuit 302 is a circuit which multiplies “one minus a setting value of the compressibility setting register 107” by a pre-compression data amount containing one block, thereby to calculate a code length corresponding to one block and making a target. The code-length-prediction circuit 301 is a circuit which divides after-orthogonal transformation data by a plurality of predetermined quantization parameter, thereby to calculate an after-entropy-coding code length containing one block for each quantization parameter. The quantization parameter decision circuit 303 is a circuit which selects, from among outputs of the code-length-prediction circuit 301, a code length, which is one of code lengths not exceeding an output of the target-code-length decision circuit 302, namely a target code length, and which correspond to the smallest quantization parameter, and then outputs the quantization parameter. The quantization circuit 203 uses a quantization parameter thus determined by the quantization parameter decision circuit 303 to execute an arithmetic division, thereby quantizing the data. In general, the quantization parameter will be stored in a memory together with an entropy code.

The arrangement of the display data compression circuit as described above enables compression of display data by use of a compressibility set by the compressibility setting register.

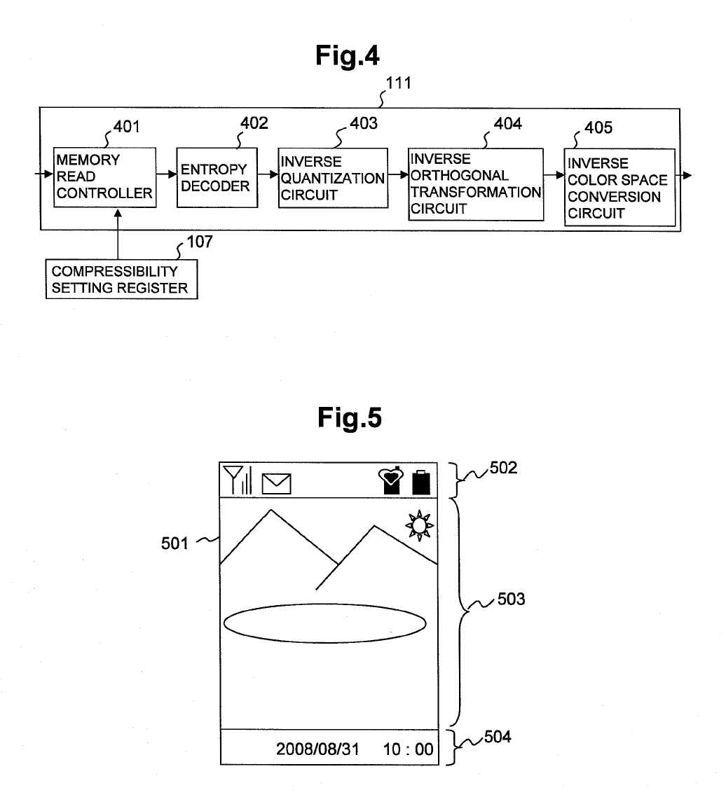

Next, with reference to FIG. 4, the circuit arrangement inside the display data decompression circuit 111 will be described in detail. The memory-read controller 401 multiplies “one minus a setting value of the compressibility setting register 107” by a pre-compression data amount containing one block, thereby to calculate a code length corresponding to one block, and reads data of a code length calculated to decode display data containing one block. Subsequently, the entropy decoder 402 converts an entropy code into numerical value data with a fixed length. Then, the inverse quantization circuit 403 multiplies the numerical value data—an output of the entropy decoder 402—by quantization parameter, whereby the inverse quantization is performed. The inverse-orthogonal-transformation circuit 404 multiplies an output of the inverse quantization circuit 403 by the inverse matrix of the orthogonal matrix. Then, the inverse-color-space conversion circuit 405 conducts the conversion from a color space for data compression to RGB color space. The arrangement of the display data decompression circuit as described above enables the decompression of display data compressed with a compressibility set by the compressibility setting register.

The arrangement like this allows the display unit according to the first embodiment to conduct a memory write with the compressibility corresponding to a compressibility set by CPU. For instance, when displaying an image having a gentle characteristic curve, such as a picture image taken by a digital camera, on the display panel 105, CPU sets a larger value on the compressibility setting register 107 to increase the compressibility. Thus, the amount of data to be written in the frame memory is reduced, and accordingly the power consumption is cut. In the case of displaying a moving picture, such as a video image taken by a video camera, CPU sets a larger value on the compressibility setting register 107 thereby to increase the compressibility, whereby the amount of data written in the frame memory and the power consumption are reduced. Incidentally, the reason for making the setting like this is that in regard to moving pictures, the deterioration of image quality tends to be inconspicuous.

In contrast, in the case of displaying an image involving many small edges, e.g. UI image, on the display panel 105, CPU sets a small value on the compressibility setting register 107, thereby to increase the amount of data written in the frame memory. Thus, the deterioration of image quality can be prevented, and therefore the image quality after decompression can be kept at a certain level or better.

The compressibility setting register is not necessarily limited to a type which outputs a numerical value. It may be arranged as follows, for example. That is, on condition that the compressibility is limited to two or more fixed values, one of such values is made to correspond to UI mode, another to Moving picture mode, and another to Natural picture mode.

### Second Embodiment

Next, the display unit according to the second embodiment of the invention will be described with reference to FIGS. 5 to 8.

The major difference between the second embodiment and the first embodiment is that in the second embodiment, the display region thereof is parted into two or more areas, and the compressibility can be changed for each area.

In general, a display screen 501 of a mobile phone or the like, is parted into a standby image 503 of a natural picture, and UI (User Interface) image display areas 502 and 504 where a time display, various kinds of icons and the like are laid out, as shown in FIG. 5.

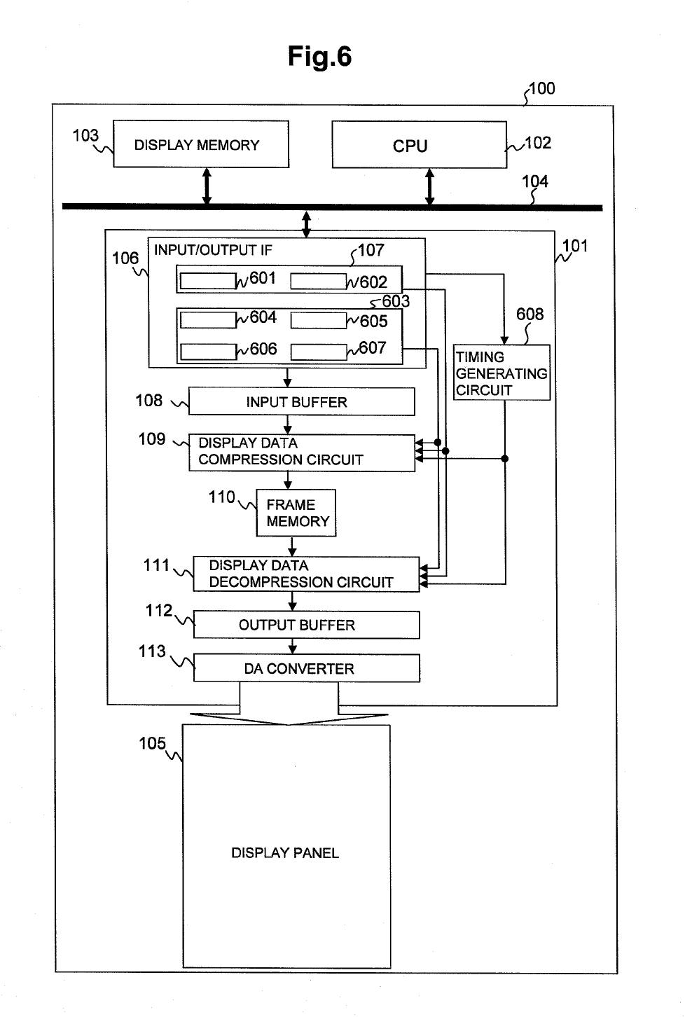

FIG. 6 is a block diagram showing the display unit according to the second embodiment. Comparison with the block diagram of FIG. 1 has shown that unlike the display unit according to the first embodiment, the display unit 100 according to the second embodiment has a display-area-setting register 603, and first and second area-compressibility setting registers 601 and 602 provided in the compressibility setting register 107, which enable the setting of a compressibility on an individual area basis. The display-area-setting register 603 has a first area upper-left X-coordinate setting register 604, a first area upper-left Y-coordinate setting register 605, a first area lower-right X-coordinate setting register 606, and a first area lower-right Y-coordinate setting register 607. In this way, the display unit is arranged so that the first area and other display area, e.g. second area, can be set.

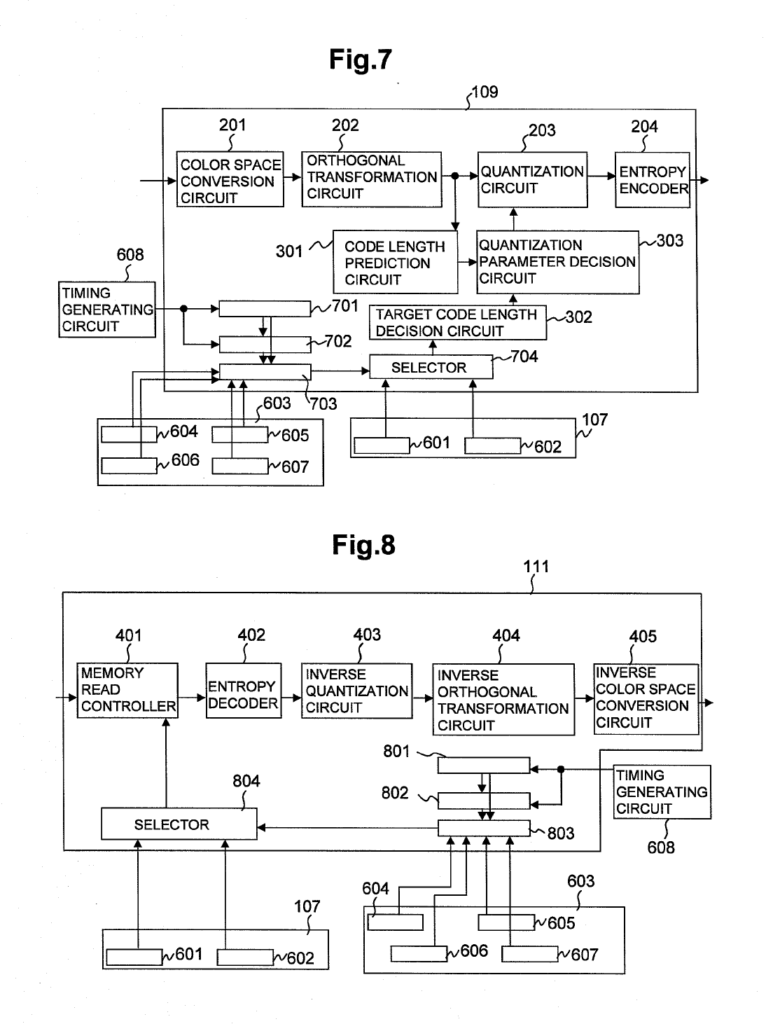

FIG. 7 is a detailed block diagram showing a data compression circuit of the display unit according to the second embodiment. The reference numerals 701 and 702 denote counters, which respectively show X and Y coordinates of a display position of display data in the middle of compression at present. The counters 701 and 702 are both reset by a frame-start signal generated by the timing generating circuit 608. The counter 701 counts up by the block size in X direction each time the step of compression of one block ends. The counter 702 counts up by the block size in Y direction each time the processing of one line ends. The numeral 703 denotes a comparator, which outputs a first area signal showing that the position of display data currently in question is in the first area when the following two conditions are satisfied, and otherwise outputs a second area signal: the count value of the counter 701 is between the value of the first area upper-left X-coordinate setting register 604, and the value of the first area lower-right X-coordinate setting register 606 inclusive; and the count value of the counter 702 is between the value of the first area upper-left Y-coordinate setting register 605 and the value of the first area lower-right Y-coordinate setting register 607 inclusive. The selector 704 outputs the value of the first area-compressibility setting register 601 to the target-code-length-decision circuit 302 on receipt of the first area signal as an output of the comparator 703, and outputs the value of the second area-compressibility setting register 602 on receipt of the second area signal.

FIG. 8 is a detailed block diagram showing a data decompression circuit of the display unit according to the second embodiment. The reference numerals 801 and 802 denote counters. The numeral 803 denotes a comparator, which outputs a first area signal showing that the position of display data currently in question is in the first area when the following two conditions are satisfied, and otherwise outputs a second area signal: the count value of the counter 801 is between the value of the first area upper-left X-coordinate setting register 604, and the value of the first area lower-right X-coordinate setting register 606 inclusive; and the count value of the counter 802 is between the value of the first area upper-left Y-coordinate setting register 605 and the value of the first area lower-right Y-coordinate setting register 607 inclusive. The selector 804 outputs the value of the first area-compressibility setting register 601 to the memory-read controller 401 on receipt of the first area signal as an output of the comparator 803, and outputs the value of the second area-compressibility setting register 602 on receipt of the second area signal. Thus, even in case that the compressibility is changed halfway through the display of one frame, it is possible to read data of an amount depending on the compressibility, and therefore a correct decomposition can be performed.

Now, with reference to FIG. 5 again, the setting of the display screen 501 will be described. First, the area 503 is made the first area to set the coordinates of upper-left and lower-right corner points in the display-area-setting register 603. Subsequently, a relatively high compressibility is set in the first area-compressibility setting register 601 for a natural picture, and a relatively low compressibility is set in the second area-compressibility setting register 602 for UI image. In this way, the image quality after decompression can be kept at a certain level or better for all regions, and as to the region 503, the compressibility can be increased. As a result, the power consumption can be reduced to a lower level.

### Third Embodiment

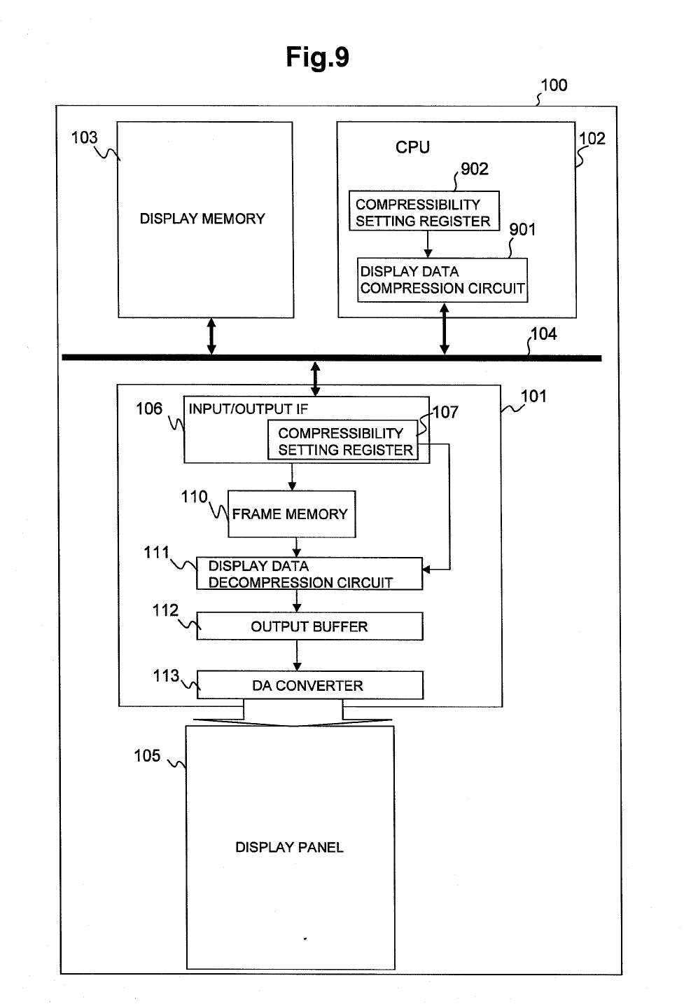

Now, with reference to FIG. 9, the third embodiment of the invention will be described.

The major difference between the third embodiment and the first and second embodiments is that in the third embodiment, CPU 102 includes a display data compression circuit 901.

The display data compression circuit 901 is identical to the display data compression circuit 109 of the display unit according to the first embodiment in function. The display data compression circuit 901 compresses displayed image according to the set value of the compressibility setting register 902 in CPU 102, and transmits the data to the display driver 101 through an internal bus 104. Alternatively, the display data may be sent to the display driver 101 from CPU 102 directly, or otherwise the compressed data may be transferred from CPU 102 to the display memory 103 and stored there once, and then transmitted from the display memory 103 to the display driver 101. At the time of display, CPU 102 sets a value of the compressibility setting register 902, which was put there at the time of compression, in the compressibility setting register 107 in the display driver 101. With the display unit arranged as described above, in which the data compression circuit is provided in CPU, and compressed data is transferred from there, the number of times of switching of the internal bus can be largely reduced, and the power consumption can be lowered. Also, the display unit according to the third embodiment brings the advantage that the time during which the bus stays busy can be shortened, and therefore the surplus time can be assigned to data transfer by other function such as a touch panel.

### Fourth Embodiment

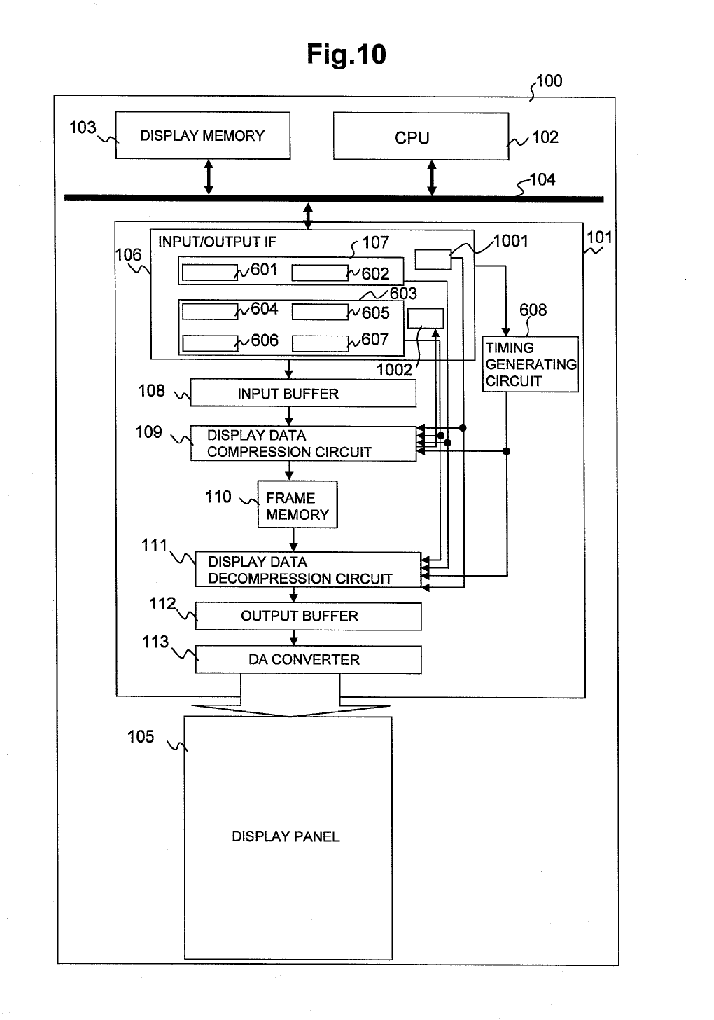

Next, with reference to FIGS. 10, 13 and 14, the fourth embodiment of the invention will be described.

There are two major differences between the fourth embodiment and the first to third embodiments. The first is that the way of compression can be switched depending on a displayed image. The second is that the compressibility of an image can be switched automatically according to the degree of deterioration of an image after decompression of display data.

In regard to the display unit shown in FIG. 10, the reference numeral 1001 denotes a compression-mode-switching register for Second Area shown in FIG. 5—composed of the areas 502 and 504. In regard to an image as in Second Area, which is often UI image, BTC method can offer a better after-decompression image quality rather than a combination of the orthogonal transformation and entropy code. An example of such case is when the number of colors is small. CPU 102 can set BTC mode on the compression-mode-switching register 1001 thereby to select BTC method as a means for compressing Second Area, which depends on the design of a displayed image.

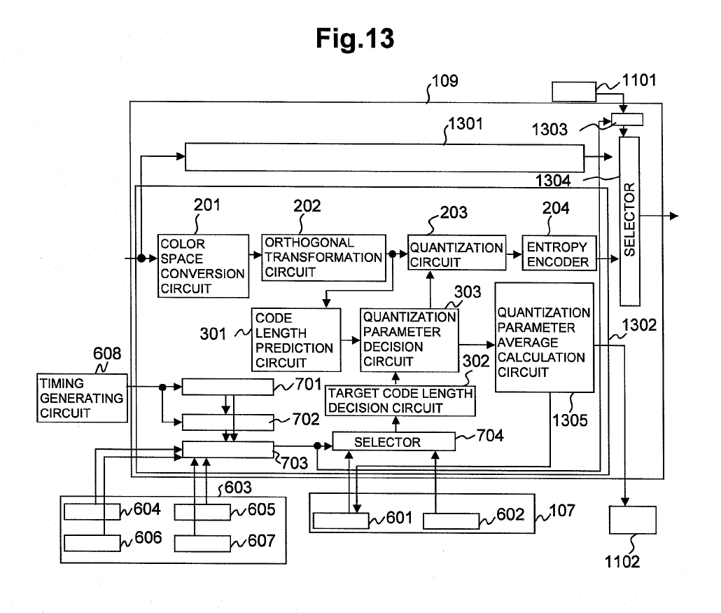

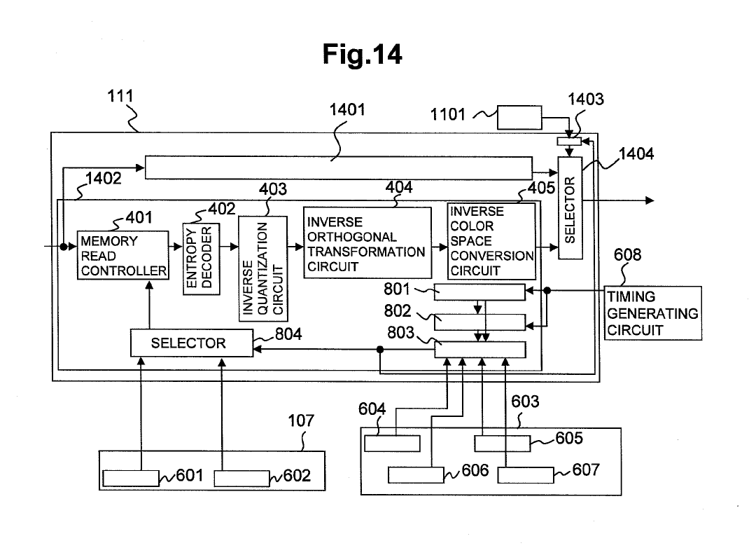

FIGS. 13 and 14 are detailed block diagrams showing the display data compression circuit 109 and display data decompression circuit 111 of the display unit according to the fourth embodiment, respectively.

As to the display data compression circuit of FIG. 13, the reference numeral 1301 denotes a BTC compression circuit having the function of the circuit block shown in FIG. 11. The orthogonal-transformation-compression circuit 1302 is a circuit which conducts a compression following a combination of the orthogonal transformation and entropy code, and which is identical to the display data compression circuit 109 of the display unit according to the second embodiment except having the function of automatic compression.

In the display data compression circuit of FIG. 13, the AND circuit 1303 outputs a signal of BTC mode on condition that the area-judging circuit 703 outputs a second area signal, and BTC mode is set in the compression-mode-switching register 1001. The AND circuit 1303 outputs a signal of non-BTC mode on condition that the area-judging circuit 703 doesn't output a second area signal, or BTC mode is not set on the compression-mode-switching register 1001. The selector 1304 sends out, as its output, an output of the BTC compression circuit 1301 on condition that the AND circuit 1303 is in BTC mode. The selector 1304 sends out, as its output, an output of the orthogonal-transformation-compression circuit 1302 on condition that the AND circuit 1303 is in non-BTC mode. Using the display data compression circuit working in this way, the second area can be compressed by BTC method.

Further, in the display data compression circuit of FIG. 13, the reference numeral 1305 denotes a quantization parameter average calculation circuit. In general, in the case that a data compression method based on a combination of the orthogonal transformation and entropy encoder is used, as a quantization parameter is larger, the error between original data and after-decompression data widens, and the deterioration of image quality is caused accordingly. It is conceivable that the after-decompression image quality of display data is more deteriorated as the mean value of quantization parameter calculated by the quantization parameter average calculation circuit 1305 is larger. Therefore, on condition that the mean value of quantization parameter calculated by the quantization parameter average calculation circuit 1305 exceeds a certain value, the certain value is subtracted from a set value held by the compressibility setting register 601 for First Area, and a display data retransmission request is issued to the retransmission-request status register 1002. Executing the action like this, the retransmitted display data can be compressed again with a compressibility reduced by the certain value. As a result, the image quality can be kept at a certain level automatically.

Conversely, on condition that the mean value of quantization parameter calculated by the quantization parameter average calculation circuit 1305 is smaller than the certain value, it can be expected that the image quality can be kept at a certain level or better even if the display data is compressed further. Therefore, in case that the mean value of quantization parameter calculated by the quantization parameter average calculation circuit 1305 is smaller than the certain value, the certain value is added to the set value held by the compressibility setting register 601 for First Area, and a display data retransmission request is output to the retransmission-request status register 1002. Executing the action like this, the retransmitted display data can be compressed again with a compressibility raised by the certain value. As a result, the power consumed by readout from the frame memory can be reduced.

With the display data decompression circuit of FIG. 14, the reference numeral 1401 denotes a BTC decompression circuit, which has the function of producing decompression data 1205 from typical values 1202 and 1203, and pixel values 1204 as shown in FIG. 12. The orthogonal transformation decompression circuit 1402 is a circuit which conducts decompression according to a combination of the orthogonal transformation and entropy code, and which is identical to the display data decompression circuit 111 of the display unit according to the second embodiment.

In general, the number of times of reads is much larger than the number of times of writes in display of a still image. Therefore, even if CPU retransmits display data on several occasions, such actions have no significant impact on the power consumption. Thanks to such several times of retransmissions, the power consumption can be controlled to a minimum while keeping the image quality at a certain level automatically.

However, in display of a moving picture, CPU sends display data of the subsequent frame instead of retransmitting the data. As a result, it becomes possible to use, as the compressibility for the subsequent frame, the compressibility changed by the mean value of quantization parameter of the preceding frame calculated by the quantization parameter average calculation circuit 1305. A moving picture has a large correlation between frames. Therefore, by controlling the compressibility in this way, the power consumption can be controlled to a minimum while keeping the image quality at a certain level automatically.

While the invention made by the inventor has been specifically described above, it is not limited to the description. It is obvious that various changes and modifications may be made without departing from the subject matter thereof.

The invention is applicable to display units, such as LC displays of e.g. mobile phones and hand-held game machines, and organic electro-luminescence displays, and display drivers.

What is claimed is:

1. A display driver comprising:
a display data compression circuit operable to compress display data of an image thereby to reduce a data amount of the display data;
a recording circuit operable to store the display data compressed by the display data compression circuit;
a display data decompression circuit operable to decompress the display data read from the recording circuit; and
an output circuit operable to output the display data decompressed by the display data decompression circuit to a display section,
wherein the display driver includes a compressibility setting circuit operable to set a compressibility of the display data, and
the display data compression circuit includes a function for compressing the display data with the compressibility set by the compressibility setting circuit.

2. The display driver according to claim 1, further comprising a display area setting circuit operable to set a plurality of display area,
wherein the compressibility setting circuit includes a function for setting a compressibility corresponding to each display area, and
the display data compression circuit includes a function for switching the compressibility and compressing the display data according to a value set by the display area setting circuit, and a display position of the display data.

3. The display driver according to claim 2, further comprising a compression-mode setting circuit operable to set a compression mode corresponding to each display area,
wherein the display data compression circuit switches the compression mode and compresses the display data according to a value set by the compression-mode setting circuit and a display position of the display data.

4. The display driver according to claim 1, further comprising a circuit operable to update a value set by the compressibility setting circuit,
wherein the compression of display data of an image includes at least the step of performing quantization using a quantization parameter, and
the update is conducted depending on a value taken by the quantization parameter.

5. A display unit, comprising:
a display driver including a CPU having a display data compression circuit operable to compress display data of an image thereby to reduce a data amount of the display data,
a recording circuit operable to store the compressed display data,
a display data decompression circuit operable to decompress the display data read from the recording circuit, and
an output circuit operable to output the display data decompressed by the display data decompression circuit; and
a display section operable to display the display data output through the output circuit,
wherein the CPU includes a compressibility setting circuit operable to set a compressibility of the display data,
the display data compression circuit includes a function for compressing the display data according to a compressibility set by the compressibility setting circuit, and
the display data compressed by the display data compression circuit is transmitted to the display data decompression circuit through the recording circuit.
